(19) United States
(12) Patent Application Publication
(10) Pub. No.: US 2017/0069443 A1
(43) Pub. Date: Mar. 9, 2017

(54) FILM-BASED HOUSING AND SWITCH FOR KEYBOARD ASSEMBLY

(71) Applicant: Apple Inc., Cupertino, CA (US)

(72) Inventors: Paul X. Wang, Cupertino, CA (US); Ryan P. Brooks, Cupertino, CA (US); Zheng GAO, Cupertino, CA (US)

(21) Appl. No.: 15/261,978

(22) Filed: Sep. 11, 2016

Related U.S. Application Data
(63) Continuation of application No. 15/233,877, filed on Aug. 10, 2016.
(60) Provisional application No. 62/214,590, filed on Sep. 4, 2015.

(51) Int. Cl. H01H 13/14; H01H 11/00; G06F 1/16; H01H 13/83

(52) U.S. Cl. CPC H01H 13/14; H01H 13/83; H01H 11/00; G06F 1/1662; H01H 2011/0087; H01H 2203/024; H01H 2231/002

(57) ABSTRACT

A switch assembly includes a switch body defining a switch opening, a dome switch positioned in the switch opening, a film attached to a surface of the switch body and covering the switch opening, and a protrusion extending from the film in an area above the switch opening. The protrusion is configured to transfer a force from a keycap of a key to the dome switch when the keycap is depressed. The dome switch may include an upper dome below the film and a lower dome below the upper dome.

### CROSS-REFERENCE TO RELATED APPLICATION(S)

This application is a nonprovisional patent application of and claims the benefit of U.S. Provisional 62/214,590, filed Sep. 4, 2015 and titled “Film-Based Housing and Switch for Keyboard Assembly,” the disclosure of which is hereby incorporated by reference herein in its entirety.

### FIELD

The disclosure relates generally to a switch assembly for an electronic device and, more particularly, to a switch assembly having a film forming an upper surface of the switch assembly.

### BACKGROUND

Electronic devices typically include one or more input devices such as keyboards, touchpads, mice, or touchscreens to enable a user to interact with the device. These devices can be integrated into an electronic device or can stand alone as discrete devices that can transmit signals to another device or to a processor via wired or wireless connection. For example, a keyboard can be integrated into the casing or housing of a laptop computer, and can transmit signals or otherwise provide inputs to a processor of the laptop computer.

Keyboards typically include multiple individual keys. Each individual key may include multiple components, such as a keycap or other input surface for receiving physical input from a user, mechanisms for supporting the keycap, and electrical components that allow the electronic device to detect when a key has been pressed.

### SUMMARY

A switch assembly includes a switch body defining a switch opening therein, a dome switch positioned in the switch opening, a film attached to a surface of the switch body and covering the switch opening, and a protrusion extending from the film in an area above the switch opening. The protrusion is configured to transfer a force from a keycap of a key to the dome switch when the keycap is depressed. The dome switch may include an upper dome below the film and a lower dome below the upper dome. The switch assembly may further include a support mechanism movably supporting the keycap relative to the keyboard base.

The switch assembly may be one of a group of switch assemblies of a keyboard comprising a keyboard base and a group of keycaps movably supported relative to the keyboard base. The keycap may be one of the group of keycaps. Each respective switch assembly of the group of switch assemblies may be coupled to a keyboard base and may be positioned under a respective keycap of the group of keycaps. The keyboard may be coupled to an electronic device that detects inputs resulting from actuation of the keycaps.

The film of the switch assembly may be formed from an elastomeric material. The switch body may be formed from a first material, and the film may be formed from a second material different from the first material. The second material may be substantially transparent or substantially reflective. The second material may be configured to disperse light towards the keycap, the light having been directed into the switch body from a light source. The film may be directly adjacent the dome switch.

A key may include a switch assembly. The switch assembly may include a body defining a switch opening therein, a flexible cover joined to the body, an actuation pad on a surface of the flexible cover, and a keycap positioned above the switch assembly and operative to move from a first position to a second position. In the first position, the flexible cover is in a substantially undeformed state. In the second position, the flexible cover is deformed by the keycap.

The keycap may include a contact protrusion configured to contact the actuation pad when the keycap is in the second position. The switch opening may be defined by an edge having a recess therein. The key may further include a dome switch positioned within the switch opening, where a portion of the dome switch is received in the recess. The key may further include an upper dome positioned adjacent the actuation pad, and a lower dome disposed below the upper dome. The actuation pad may deform the upper dome when the keycap is in the second position. The upper dome may complete an electrical connection with the lower dome when the keycap is in the second position. The dome switch may include a dome protrusion on a surface of the dome switch. The actuation pad may be configured to deform the dome switch when the keycap is moved to the second position, and the dome protrusion may be configured to contact an electrical terminal below the dome switch when the dome switch is deformed.

A method of forming a switch includes attaching a cover member comprising an actuation pad to a switch body that defines a switch opening, and positioning a dome switch within the switch opening such that the actuation pad is aligned with an input surface of the dome switch.

The method may further include forming the cover member, wherein forming the cover member comprises attaching the actuation pad to a film. The operation of attaching the actuation pad to the film may include laser welding the actuation pad to the film. The operation of attaching the cover member to the switch body may include laser welding the film to the switch body around a perimeter of the switch body.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts an example electronic device including a keyboard assembly;

FIG. 2 depicts an exploded view of an example switch of a keyboard assembly;

FIG. 3 illustrates a top view of the assembled switch of FIG. 2;

FIG. 4 is a cross-sectional view of the assembled switch of FIG. 3, viewed along line CS-CS of FIG. 3;

FIG. 5 depicts an exploded view of another example switch of a keyboard assembly:

FIG. 6 illustrates a top view of the assembled switch of FIG. 5;

FIG. 7 is a cross-sectional view of the assembled switch of FIG. 6, viewed along line CS-CS of FIG. 6;

FIG. 8A illustrates a first state of actuation of the switch of FIG. 7;

FIG. 8B illustrates a second state of actuation of the switch of FIG. 7;

FIG. 9 depicts an exploded view of yet another example switch of a keyboard assembly;

FIG. 10 illustrates a top view of the assembled switch of FIG. 9;

FIG. 11 is a cross-sectional view of the assembled switch of FIG. 10, viewed along line CS-CS of FIG. 10;

FIG. 12 is a cross-sectional view of still another example switch; and

FIG. 13 is a flow chart illustrating an example method for assembling a switch.

### DETAILED DESCRIPTION

Reference will now be made in detail to representative embodiments illustrated in the accompanying drawings. It should be understood that the following descriptions are not intended to limit the embodiments to one preferred embodiment. To the contrary, they are intended to cover alternatives, modifications, and equivalents as can be included within the spirit and scope of the described embodiments as defined by the appended claims.

The following disclosure relates generally to switch assemblies, and more particularly to switch assemblies that include cover members that are attached to switch bodies to cover a dome or other switch positioned in the switch body. The cover member may act as a seal to keep foreign matter and contaminants out of the switch body, and may include actuation pads or other members or features that transfer force from a keycap to the underlying switch (e.g., a dome switch). Such switch assemblies may be used in input mechanisms such as keyboard keys, buttons, or the like.

In some embodiments, the cover member includes a protrusion attached to or otherwise extending from either a top or bottom surface of a film. This protrusion, sometimes referred to herein as an actuation pad or a “key-bump,” acts as an offset or shim to provide a certain distance between the film and a keycap impacting the switch during operation of the switch. The key-bump also acts to transfer force from the keycap to the dome to impart an actuation force to the dome. In some cases, the key-bump (or other protrusion) may have a sufficient stiffness or rigidity to transfer an actuation force to the dome without substantial deformation or flexing that may reduce or impair tactile feedback to the user.

Switches or keys that include cover members with the key-bumps described herein may provide efficient, reliable input in a relatively compact key height. For example, a key may travel as little as 50-75 mm and still provide an input and a reliable, pleasing tactile feedback. In some embodiments, the key-bump is cylindrical, although other shapes are also contemplated (e.g., rectangular prisms).

In addition, keys or other input mechanisms may include light sources or illuminators, such as one or more light emitting diodes (LEDs), and the switch assembly may operate as and/or include a light guide. In such implementations, the film, the switch body, and/or other components of a switch assembly may be configured such that the illuminator illuminates the key, a legend (such as a letter, number, symbol, glyph, and/or other pattern) on a surface of the key, and so on.

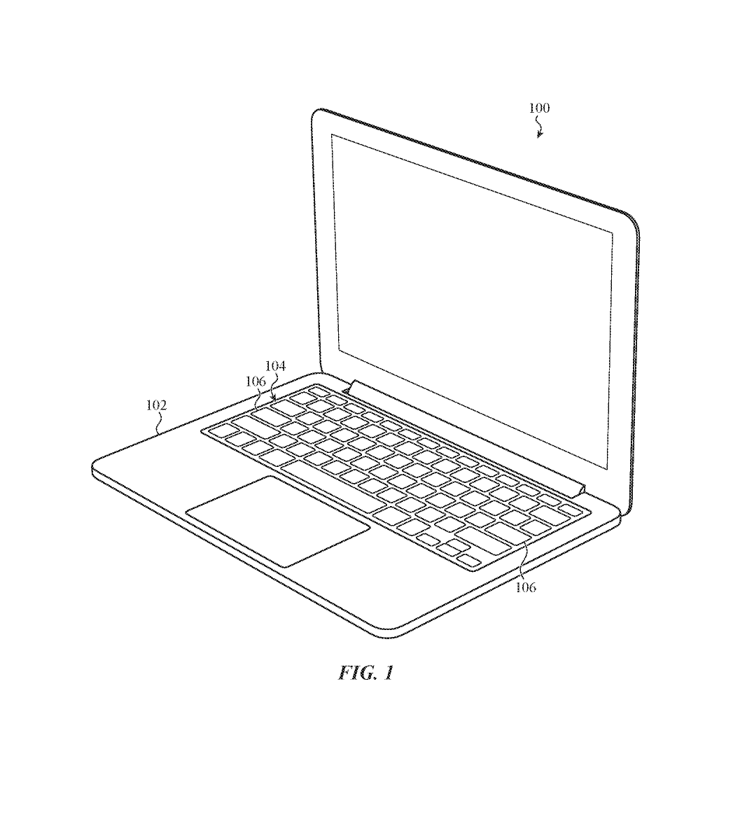

Although structures, operations, and methods of manufacture may be described herein with respect to a key of a keyboard, it should be appreciated that the instant disclosure is equally applicable to other input devices. Thus, mice, input buttons, trackpads, and the like may also incorporate the concepts described herein. The foregoing and other embodiments are discussed below with reference to FIGS. 1-13. However, those skilled in the art will readily appreciate that the detailed description given herein with respect to these Figures is for explanatory purposes only and should not be construed as limiting.

FIG. 1 depicts an example electronic device 100 including a keyboard assembly 104, according to embodiments of the present disclosure. In a non-limiting example, the electronic device 100 may be a laptop computer, though other devices are also contemplated (e.g., desktop or tablet computers, peripheral input devices, etc.). The device 100 may incorporate a keyboard 104 that includes a set of keys 106, each of which may be positioned above and may interact with a switch assembly that includes a cover member attached to a switch body, as generally described above and discussed in more detail below.

The electronic device 100 may include a top case 102. The top case 102 may take the form of an exterior, protective casing or shell for the electronic device 100 and the various internal components (for example, the keyboard assembly 104) of the electronic device 100. The top case 102 may be formed as a single, integral component or may have a group of distinct components configured to be coupled to one another, as discussed herein. Additionally, the top case 102 may be formed from any suitable material that provides a protective casing or shell for the electronic device 100 and the various components included in the electronic device 100. In non-limiting examples, the top case 102 may be made from metal, a ceramic, a rigid plastic or another polymer, a fiber-matrix composite, and so on.

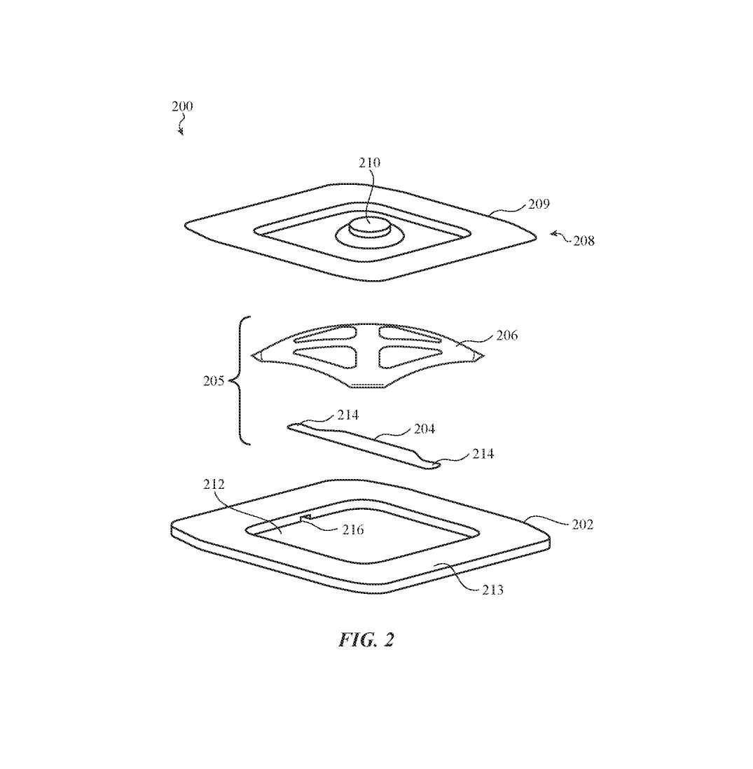

The keyboard assembly 104 may be included within the electronic device 100. More specifically, as shown in FIG. 1, the keyboard assembly 104 may include a set of keys 106 positioned within the top case 102 of the electronic device 100. Keycaps or other portions of the keys 106 may partially protrude from the top case 102 and each may be substantially surrounded by a portion of the top case 102 (e.g., a web or frame portion of the top case 102). That is, the set of keys 106 of the keyboard assembly 104 may extend beyond (e.g., above) a surface of the top case 102 and may be divided or separated by a portion of top case 102. In the non-limiting example shown in FIG. 1, where the electronic device 100 is a laptop computer, the keyboard assembly 104 may be positioned within and/or may be received by the electronic device 100. In an additional embodiment, the keyboard assembly 104 may be a distinct, standalone component and may be in electronic communication (for example, via wired or wireless communications techniques) with the electronic device 100 or a different electronic device such as a tablet or desktop computer. Example structures of an individual key are discussed in more detail below with respect to FIGS. 2-12.

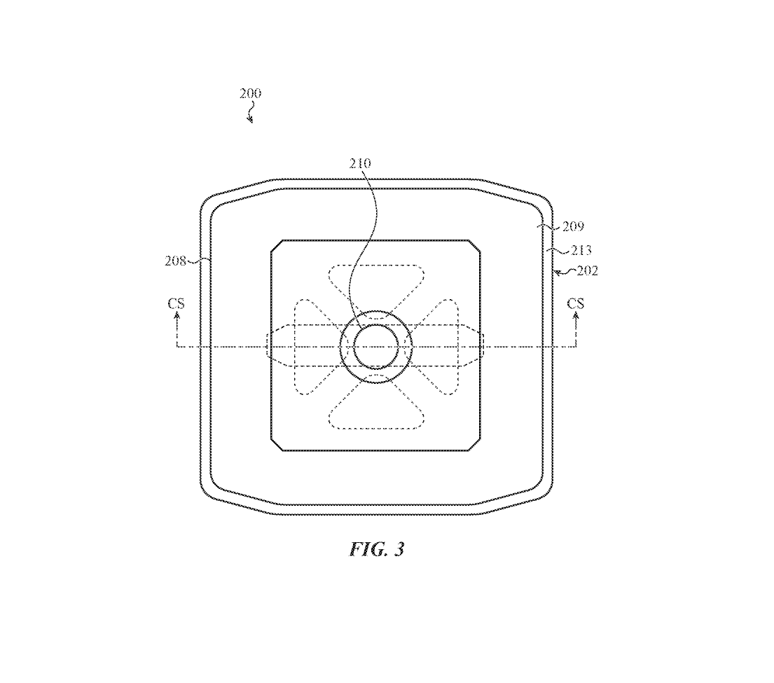

FIGS. 2 and 3 depict an example switch assembly 200 (also referred to simply as a switch) of a keyboard assembly in an exploded view (FIG. 2) and a top view (FIG. 3), according to embodiments. As shown in the figures, a switch assembly for receiving and/or housing a dome switch 205 may be formed from a cover member 208, which may act as a light guide, and a switch body 202. The cover member 208 may also be configured to receive a force from a keycap, buckle or deform in response to that force, and subsequently collapse or deform a dome switch positioned in the switch assembly, as further described herein.

The cover member 208, which may be flexible, may be positioned over a switch opening 212 in the switch body 202 and may overlap (and be attached to) at least a portion of a top surface 213 of the switch body 202. The switch assembly 200 may be formed using a double-shot molding process to integrally form the flexible cover member 208 with the switch body 202, wherein the switch body 202 comprises a first shot, and the cover member 208 comprises a second shot (or vice versa). Alternatively, the cover member 208 may be attached to the switch body 202 using other techniques, such as adhesives, laser or ultrasonic welding, localized melt joining, or the like.

Upper and lower dome structures 206, 204, which together form a dome switch 205, may be positioned within the switch opening 212 of the switch body 202, and may be held in place by being biased against the switch body 202. One or both of the upper and lower dome structure 206, 204 may also or instead be held in place by being captured between the switch body 202 (or a portion thereof) and a substrate such as a printed circuit board (not shown in FIG. 2) when the switch assembly 200 is connected to the substrate. Although the upper and lower dome structures 206, 204 are described herein as “domes”, they may be configured as a strip, plane, surface, etc., and still function as a dome or dome switch within the scope of the present disclosure.

The cover member 208 may have an actuation pad 210 or other protrusion extending from a surface, such as an upper or lower surface, of the film 209. The actuation pad/protrusion 210 may be integrally formed with the film 209 (e.g., the film 209 and the actuation pad 210 or other protrusion may be a unitary component formed from a single piece of material), or the actuation pad 210 may be a separate component that is attached to the film 209. As shown, the actuation pad 210 and the film 209 are a unitary component formed of a single piece of material.

The actuation pad 210 may be positioned above the switch opening 212 of the switch body 202 and may be substantially aligned with an input surface of the dome switch 205 (comprised of upper and lower dome structures 206, 204) when dome switch 205 is positioned in the switch opening 212. That is, the actuation pad 210 may be positioned relative to the dome switch 205 such that the actuation pad 210 contacts the dome switch 205 (or otherwise imparts a force on the dome switch 205) when a keycap applies an actuation force to the actuation pad 210.

Although a particular order of assembly may be implied by the discussion of FIG. 2, it is understood that this is an example. In various implementations, the above-discussed components and/or other components may be assembled in different orders or using different techniques without departing from the scope of the present disclosure.

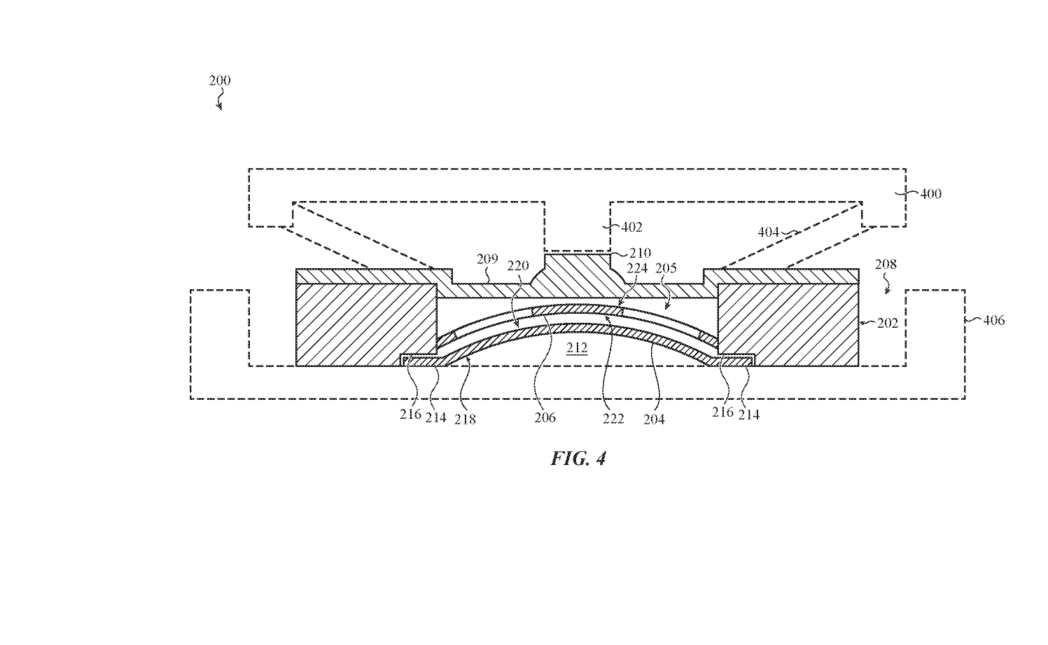

FIG. 4 is a cross-sectional view of the assembled switch assembly 200 of FIGS. 2 and 3, viewed along line CS-CS of FIG. 3. As shown in FIG. 4, the switch assembly 200 includes the switch body 202, the cover member 208, and the dome switch 205 comprising the lower dome 204 and the upper dome 206. The switch assembly 200 may be positioned between a keycap 400 (shown in phantom) and a substrate 406 (also shown in phantom) such as a printed circuit board having an electrical contact. The keycap 400 may be coupled to a hinge or other support mechanism 404 (e.g., a scissor mechanism) that is coupled to the substrate 406 and/or the switch body 202 which movably supports the keycap 400. In particular, the support mechanism 404 may allow the keycap 400 to be moved from an undepressed state to a depressed state in response to an actuation force applied to the keycap 400. Additionally, and as discussed in greater detail below, the dome switch 205 may be positioned below the keycap 400 in the switch opening 212 such that depression of the keycap 400 subsequently deflects the dome switch 205 to complete an electrical connection or path. An electronic device (e.g., the electronic device 100) may detect the completion of the electrical connection or path and register a key input based upon the detection.

The keycap 400, the substrate 406, and the hinge mechanism 404 are shown in phantom in FIG. 4 to illustrate a potential embodiment of the switch assembly 200 assembled within a keyboard assembly. It should be understood, however, that the structure of the keyboard assembly is not limited to the keycap 400 and the substrate 406 depicted in FIG. 4. In other words, the switch assembly 200 may be assembled with an alternative keycap and substrate structure, and still be within the scope of the present disclosure.

As shown in FIG. 4, the switch assembly 200 includes the switch body 202 and the cover member 208 attached to the switch body 202. The switch body 202 may include or define the switch opening 212 therein. The switch body 202 and the cover member 208 may be formed from different materials. In a non-limiting example, the switch body 202 may be formed from a first material having substantially rigid properties for supporting the keycap 400 during operation of a keyboard assembly and/or protecting the dome switch 205 (e.g., the upper and lower domes 206, 204) within the switch assembly 200. In some cases, the switch body 202 may include or be formed from an at least semi-transparent (e.g., translucent or transparent) material for transmitting and/or dispersing light emitted by a light source (not shown) toward the keycap 400. The switch assembly 200 may also or instead include reflective materials that guide or disperse light toward the keycap 400. For example, a reflective layer (not shown) may be formed on a bottom surface of the switch body 202 or disposed below the switch body 202. As another example, the switch body 202 may be formed of or include a reflective material.

The cover member 208, and more particularly the film 209 of the cover member 208, may be attached to the switch body 202 in any suitable way, as described above. For example, the cover member 208 and the switch body 202 may be co-molded or insert molded, which may result in a secure bond or attachment between the cover member 208 and the switch body 202. In some cases, the cover member 208 may be adhered to the switch body 202, for example, using a pressure or heat sensitive adhesive, epoxy, or the like. In some cases, the cover member 208 may be bonded in other ways, such as laser welding or ultrasonic welding or any other suitable technique.

The cover member 208 may be formed from a material (e.g., a second material) that is different from the material that forms the switch body 202 (e.g., a first material). The material or materials forming the cover member 208 may be substantially flexible or deformable. For example, the cover member 208 may be formed from or include silicone or another elastomeric material. Accordingly, the flexible cover member 208 may substantially flex when the keycap 400 is depressed, but may return to its initial state when the keycap 400 is released. Because of the flexibility and/or resilience of the second material, the cover member 208 can effectively seal the switch body 202 while also producing a desirable tactile response to the key. Moreover, the cover member 208 may be configured to have little to no effect on the amount of force required to actuate the keycap 400. In particular, the cover member 208 may require very little force to deflect (relative to an amount necessary to actuate the keycap 400), and may impart very little or no preloading force to the dome switch 205. In this way, the cover member 208 does not substantially increase or decrease the force required to actuate the keycap 400 relative to a key that does not include the cover member 208.

In addition to being flexible, the second material forming the film 209 may be at least semi-transparent or otherwise light transmissive. Thus, the cover member 208 may direct light through the cover member 208 and toward the keycap 400. The cover member 208 may also include or be formed from a reflective material that redirects light toward the keycap 400. In some embodiments, the cover member 208 and/or the switch body 202 may be at least semi-transparent (e.g., light transmissive) with respect to light traveling in a first direction and reflective with respect to light traveling in a second direction, like a one-way mirror.

The cover member 208 may cover the switch opening 212, and may extend over at least part of the top surface 213 of the switch body 202 to substantially seal and protect the upper and lower domes 206, 204 within the switch opening 212. More specifically, the cover member 208 may be formed over switch opening 212 and at least a portion of the top surface 213 of the switch body 202.

As described above, the cover member 208 may include or define an actuation pad 210 (or other protrusion) extending from a surface of cover member 208, such as from an upper or lower surface. For example, as shown in FIG. 4, the actuation pad 210 extends from a top surface of the cover member 208. The actuation pad 210 may be positioned directly adjacent a contact protrusion 402 formed on an underside of the keycap 400. The actuation pad 210 of the cover member 208 and the contact protrusion 402 of the keycap 400 may contact one another when the keycap 400 is depressed. Accordingly, the contact protrusion 402 may impart a force to the actuation pad 210, which in turn imparts the actuation force to the dome switch 205.

When the actuation force is applied to the dome switch 205, the dome switch 205 (or a component thereof) may deform or deflect in such a way that an electrical or conductive connection is formed, thus allowing an input to be detected. The interaction between the actuation pad 210 and the contact protrusion 402 of the keycap 400 may more evenly distribute the force applied to the dome switch 205 when the keycap 400 is depressed, as compared to a direct contact between a keycap 400 and a dome switch 205. By distributing the force through the cover member 208 using the actuation pad 210, the wear on dome switch 205 may be reduced over the operational life of a keyboard assembly, thereby increasing the durability and reliability of the keyboard assembly 104.

As discussed herein, and as shown in FIG. 4, the dome switch 205 may include the upper dome 206 and a lower dome 204. In some embodiments, the lower dome 204 may be disposed within or underneath the upper dome 206. The upper and lower domes 206, 204 may be deflected as the keycap 400 is actuated or depressed, thus forming an electrical connection or otherwise producing an electrical event that can be detected by an electronic device (e.g., the electronic device 100, FIG. 1). In a non-limiting example, when the keycap 400 is depressed (e.g., moved from a first position to a second position), a force may be applied to a top portion 224 of the upper dome 206 via the cover member 208 to deform the upper dome 206 of the dome switch 205. As force is continually applied to the keycap 400, the upper dome 206 may further deform and a bottom portion 222 of the upper dome 206 may contact an upper portion 220 of the lower dome 204 to form an electrical connection between the domes. As noted above, one or both of the lower dome 204 and the upper dome 206 may be electrically coupled to electrical contacts or terminals on the substrate 406. Thus, the electrical connection between the upper and lower domes 206, 204 may complete an electrical path between the terminals or contacts on the substrate 406, which can then be detected by an associated electronic device to register an input.

The upper and lower domes 206, 204 of dome switch 205 may be positioned within the switch opening 212 of the switch body 202. More specifically, the upper and lower domes 206, 204 may be substantially secured or retained to the switch body 202 to prevent or limit the dome switch 205 from moving within the switch opening 212, and ultimately to prevent the dome switch 205 from being electrically disconnected and/or otherwise unable to form an electrical connection within a keyboard assembly.

As shown in FIG. 4, the upper dome 206 of the dome switch 205 may be coupled to and/or positioned at least partially within the switch opening 212 of the switch body 202. The upper dome 206 of the dome switch 205 may be secured within the switch opening 212 by being biased against the switch body 202. For example, edges of the upper dome 206 may be forced outward such that they press against a wall (or edge) that defines the switch opening 212. The force of the edges of the upper dome 206 against the wall may produce sufficient force to retain the upper dome 206 in the switch body 202.

In some embodiments, the lower dome 204 of the dome switch 205 may include a bottom surface 218 connected to a portion of the substrate 406 and, more particularly, to an electrical contact or terminal (not shown) disposed on the substrate 406. Further, in order to retain the lower dome 204 in position, ends 214 of the lower dome 204 may be positioned within and/or coupled to recesses 216 formed in a wall or edge of the switch body 202. As shown in FIG. 4, the recess 216 may extend only partially into the switch body 202 and may be adjacent the substrate 406. That is, the substrate 406 may define a surface of a cavity into which the ends 214 of the lower dome 204 extend. The ends 214 of the lower dome 204 may be protrusions, projections, semicircular sections, or the like. Typically, although not necessarily, multiple ends 214 project from a single dome. For example, the lower dome 204 has a beam-like shape including two ends 214. Although not shown, the switch body 202 may include additional features for securing the ends 214 within the recesses 216. For example, the recesses 216 may include one or a combination of features such as barbs or protrusions formed within the recesses 216, adhesive positioned within the recesses 216, compression or friction fit surfaces or features, and/or other features that secure the ends 214 of the lower dome 204 within the recesses 216. In addition, although not shown, the ends 214 of the lower dome 204 may be positioned at least partially through the substrate 406 and/or secured only to the substrate 406, to secure the dome switch 205 within the switch body 202 and to allow the dome switch 205 (or a portion thereof) to remain in continuous electrical contact with the substrate 406.

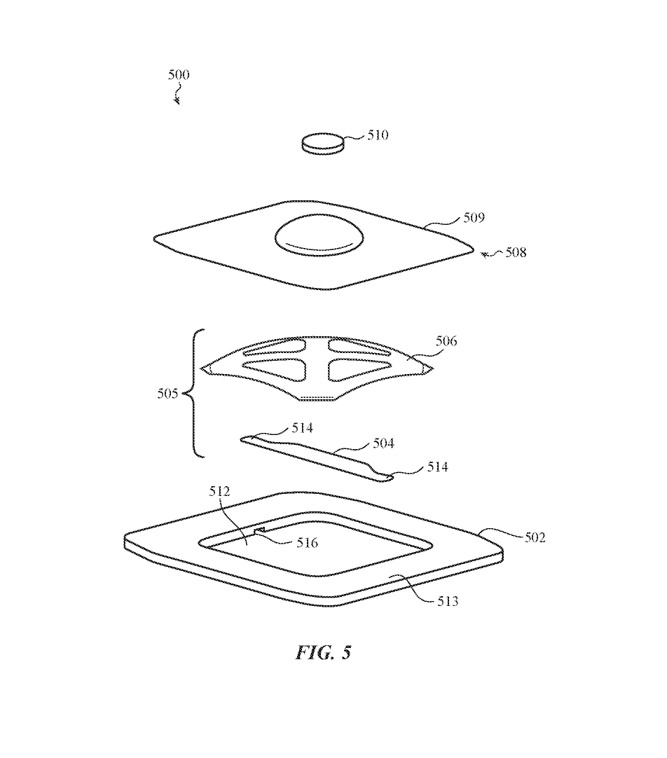

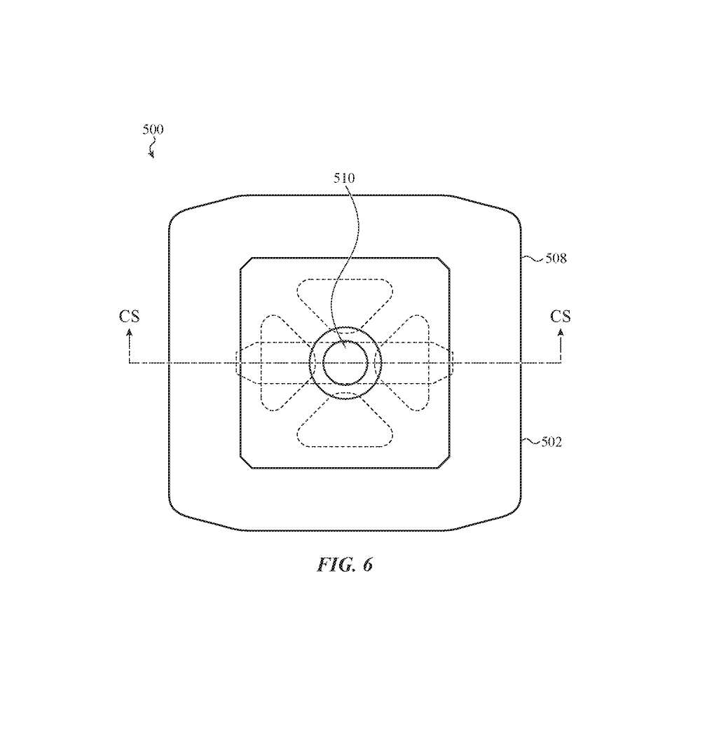

Turning now to FIGS. 5 and 6, another example switch assembly 500 of a keyboard assembly is shown in an exploded view (FIG. 5) and a top view (FIG. 6), according to various embodiments. As shown in the figures, a switch assembly 500 may include a dome switch 505, a switch body 502, and a flexible cover member 508 attached to the switch body 502. Similar to the cover member 208 described above, the cover member 508 may act as a light guide (although this is not necessary). In particular, the cover member 208 (or a portion or component thereof) may be at least semi-transparent (e.g., translucent or transparent), or may otherwise transmit or direct light therethrough. The switch body 502 may be similar in structure and function to the switch body 202, and such details are not repeated here.

The cover member 508 may include a film 509 and an actuation pad 510 (or a nub, bump, or other protrusion) extending from a surface of the film 509. Like the actuation pad 210, the actuation pad 510 may be integrally formed with the film 509, or it may be a separate component that is attached to the film 509 (as shown in FIGS. 5-7). Where the actuation pad 510 is not integrally formed with the film 509, it may be fused or otherwise attached to the film 509 using any suitable technique, such as laser welding, ultrasonic welding, adhesives, mechanical systems (e.g., clips, undercuts, etc.), or the like. In some cases, the actuation pad 510 may be coupled to the film using a molding process. For example, the actuation pad 510 may be placed in a mold and then the material for the film may be injected into the mold, thus mechanically and/or adhesively coupling the actuation pad 510 to the film 509. As another example, material for the actuation pad 510 may be injected into a mold, and then material for the film 509 may be injected into the mold (or vice versa).

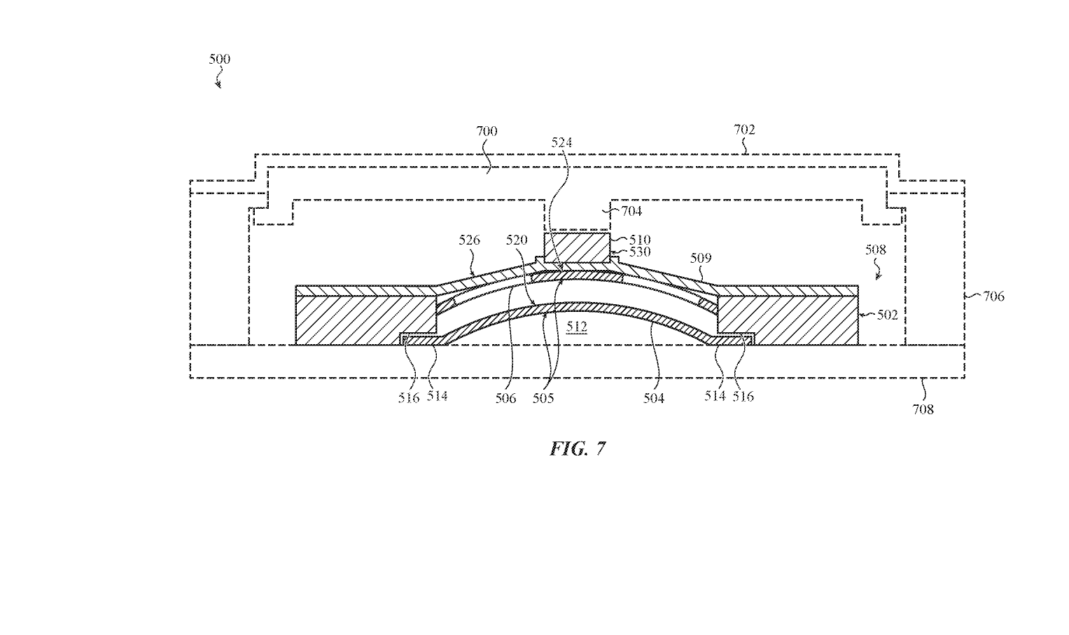

The actuation pad/protrusion 510 may be formed from any suitable material, and may be the same material as the film 509 or a different material. In some cases, the actuation pad 510 is more rigid or stiff than the film 509. For example, the film 509 may be a substantially compliant material, such as a silicone or other elastomeric material, and the actuation pad 510 may be a rigid material that does not deform substantially when subjected to a typical actuation force of a key or button of an electronic device (e.g., a metal, hard rubber, a substantially rigid plastic such as acrylonitrile butadiene styrene (ABS), or the like). As described herein, the rigid actuation pad 510 may transfer force from a keycap (e.g., the keycap 700 in FIG. 7, or any other keycap) to the dome switch 505 without substantial deflection or deformation of the actuation pad 510 itself. This may produce keys having a repeatable, consistent, and desirable tactile feel and/or response, and may produce a keyboard assembly in which each key has a substantially identical tactile feel and/or response.

The cover member 508 may be positioned over a switch opening 512 of the switch body 502 and may overlap (and be attached to) at least a portion of a top surface 513 of the switch body 502. The cover member 508 may be positioned so that the actuation pad 510 is aligned with an input surface, such as a top surface, of the dome switch 505. That is, the actuation pad 510 may be configured to engage with or otherwise transfer force from a keycap to the input surface of the dome switch 505.

The switch assembly 500 may be formed using a double-shot molding process to couple the cover member 508 to the switch body 502, wherein the switch body 502 comprises a first shot, and the cover member 508 (and more particularly the film 509) comprises a second shot (or vice versa). Alternatively, the cover member 508 may be fused or attached to the switch body 502 using other techniques, such as adhesives, laser or ultrasonic welding, localized melt joining, or the like.

Because the film 509 covers the switch opening 512 and is attached to the switch body 502, the film 509 may substantially seal and protect dome switch 505. The flexibility of the film 509 may accommodate movement or deformation of the film 509 when the keycap 700 is depressed (e.g., moved from a first position to a second position). In some cases, the film 509 may only be attached or affixed to the switch body 502 around an outer edge or perimeter of the film 509, which may also contribute to the ability of the film 509 to accommodate movement or deformation in response to a force from the keycap 700. The flexibility and/or deformability of the film 509, and optionally the way it is attached to the switch body 502, may not affect (or minimally affect) the amount of force required to actuate the keycap 700 from a default or nominal state (e.g., unactuated) to a deflected (e.g., actuated) state. Moreover, the film 509, and the cover member 508 more generally, may not substantially preload or may only minimally preload the dome switch 505. In some cases, the film 509 may be substantially undeformed when the keycap 700 is in an unactuated position (a first position), and is deformed by the keycap 700 when the keycap 200 is in an actuated position (a second position).

Like the cover member 208, the cover member 508 may be formed from or include an at least semi-transparent (e.g., translucent or transparent) material for transmitting and/or dispersing light emitted by a light source (not shown) toward a keycap, such as the keycap 700, FIG. 7. The light guiding and dispersing aspects described with respect to the switch body 202 and cover member 208 are equally applicable to the cover member 508 and the switch body 502.

In some embodiments, a dome switch 505 including upper and lower domes 506, 504 may be positioned in the switch opening 512 of the switch body 502. The dome switch 505 and the electrical and mechanical features and functions of the dome switch 505 are similar to the dome switch 205. Accordingly, the discussions of the dome switch 205 apply equally to the dome switch 505, including how the dome switch 505 is retained to the switch body 502, how the dome switch 505 completes an electrical or conductive path, etc. Such details are not repeated here.

FIG. 7 is a cross-sectional view of the assembled switch assembly 500 of FIGS. 5 and 6, viewed along line CS-CS of FIG. 6. As shown in FIG. 7, the switch assembly 500 is incorporated into a keyboard having a keycap 700 and a fabric layer 702 over the keycap 700. The keyboard in FIG. 7 also includes a substrate 708 such as a printed circuit board or other keyboard base.

The fabric layer 702 may be attached to, and/or cover, a top surface of the keycap 700 and a top surface of a frame 706. The frame 706 may be, for example, a top case of a keyboard housing (e.g., the top case 102, FIG. 1), or a web or other structural component of the keyboard. The fabric 702 may be attached to one or both of the frame 706 (or portions thereof) and the keycap 700 (or portions thereof), or it may float relative to the frame 706 and/or the keycap 700. For example, in some cases, the fabric 702 is glued, welded, or otherwise adhered to the frame 706 as well as the keycap 700. This may prevent or limit the fabric from shifting or sliding relative to the components of the keyboard. In other cases, the fabric 702 is adhered to the frame 706 but is not adhered to the keycap 700, such that the fabric 702 can float and/or slide relative to the keycap 700 but is otherwise affixed to the keyboard to prevent large-scale movements or slippage. In cases where the fabric 702 is affixed to both the keycap 700 and the frame 706, the fabric 702 may provide sufficient flexibility (and/or may be unattached to the keycap 700 and the frame 706 in strategic areas) to prevent interference with the keycap 700 during actuation of the key.

The fabric-covered keyboard configuration shown and described with respect to FIG. 7 is merely one example keyboard configuration, and the switch assembly 500 may be used in other keyboard configurations and/or with other key assemblies. For example, the switch assembly 500 may be incorporated into a keyboard like that shown in FIG. 4, where there is no fabric covering and the keycap is movably supported relative to the substrate by a hinge or scissor mechanism. Other keyboard configurations, support mechanisms, and the like, are also contemplated.

As noted above, the actuation pad 510 may be attached to a surface of the film 509, such as an upper surface 526 of the film 509. Moreover, as shown in FIG. 7, sidewalls 530 of the actuation pad 510 may be at least partially surrounded by a portion of the film 509. For example, the film 509 may include a recess that has a complementary shape and size to the actuation pad 510. The actuation pad 510 may be placed into the recess and attached or affixed to the film 509 via laser welding, adhesives, or any other suitable technique or fusing process.

While FIGS. 5-8B show the actuation pad 510 coupled to a top surface of the film 509, and thus extending above the top surface of the film 509, this is merely one example embodiment. In other cases, the actuation pad 510 may be attached to or otherwise extend from a bottom surface of the film 509. In either case, the actuation pad 510 may operate in substantially the same manner.

Like the actuation pad 210, the actuation pad 510 may be positioned relative to a contact protrusion 704 of the keycap 700 such that the contact protrusion 704 applies a force to the actuation pad 510 when the keycap 700 is actuated. This force is then transferred by the actuation pad 510 to the dome switch 505, thereby deforming or otherwise actuating the dome switch 505. The contact protrusion 704 may directly contact the actuation pad 510, or it may impart a force to the actuation pad 510 through interstitial components or layers.

As noted above, the dome switch 505 may be coupled to the switch assembly 500 and/or the keyboard in a similar way. For example, in order to retain the lower dome 504 in position, ends 514 of the lower dome 504 may be positioned within and/or coupled to recesses 516 formed in a wall or edge of the switch body 502.

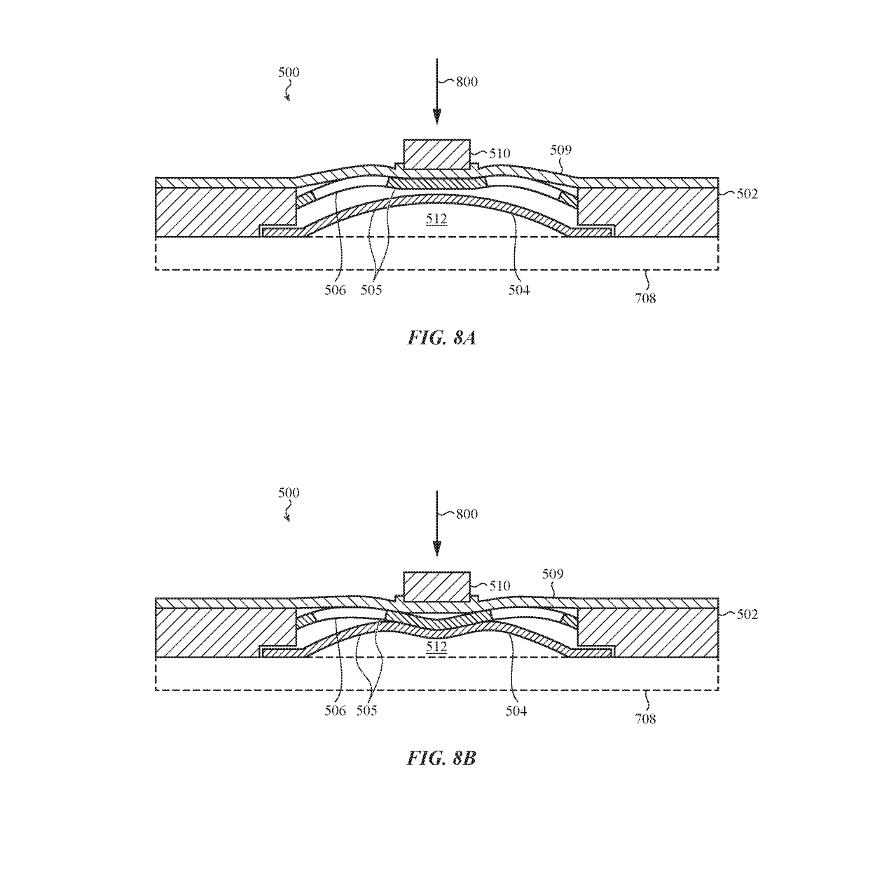

FIGS. 8A-8B are cross-sectional views of the key assembly 500, viewed along line CS-CS in FIG. 6, showing first and second states of actuation of the key assembly 500. Portions of a key or a keyboard, such as the keycap 700, the frame 706, and the like, are omitted from FIGS. 8A-8B for simplicity.

As noted above, the upper and lower domes 506, 504 may deflect as the keycap 700 is actuated or depressed in order to form an electrical connection or path that is detectible by an electronic device. Deflection of the upper dome 506 is shown in FIG. 8A, and deflection of the upper dome 506 and the lower dome 504 is shown in FIG. 8B. In FIG. 8A, when a force 800 is applied to the actuation pad 510 (which may correspond to a force exerted by a user pressing a key to depress the keycap 700 and thus move the contact protrusion 704 to contact and deflect the actuation pad 510), the cover member 508 may be deflected or deformed such that a bottom portion of the film 509 contacts and applies pressure to a top portion of the upper dome 506. Subsequently, the upper dome 506 may deform and deflect towards the lower dome 504. In FIG. 8B, as the force 800 is continually applied (or as the force 800 increases), the upper dome 506 may further deform and a bottom portion of the upper dome 506 may contact an upper portion of the lower dome 504. The contact between the upper and lower domes 506, 504 may form an electrical or conductive path (e.g., closes a circuit) that causes an electronic device to register that the key has been actuated.

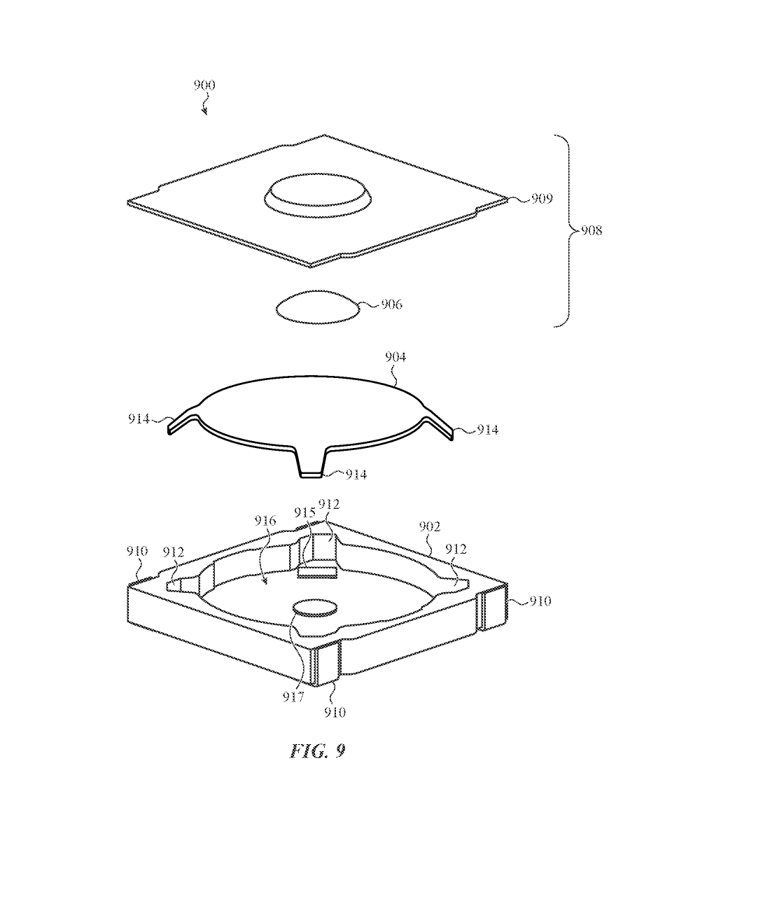

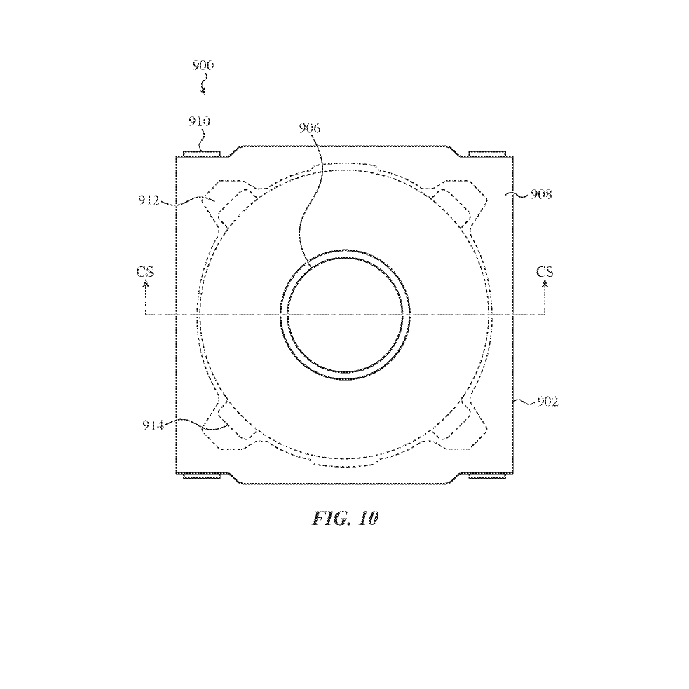

Turning now to FIGS. 9 and 10, still another example switch assembly 900 of a keyboard assembly is shown in an exploded view (FIG. 9) and a top view (FIG. 10). As shown in the figures, the switch assembly 900 for receiving and/or housing a dome switch 904, or other collapsible member, may include a flexible cover member 908 and a switch body 902. The flexible cover member 908 may include an actuation pad 906 or other protrusion or component formed on or coupled to a film 909. The actuation pad/protrusion 906 may attach to the film 909 in any suitable way, such as laser welding, ultrasonic welding, co-molding or insert molding, adhesives, or the like. In some cases, a double-shot molding process may be used to form a flexible cover member 908 where the film 909 and the actuation pad 906 are molded together but are formed from different materials. Alternatively, the cover member 908 may be a unitary component where the film 909 and actuation pad 906 are a single piece of material. Moreover, the actuation pad 906 may be coupled to (or extend from) the top or the bottom surface of the film 909. As shown, the actuation pad 906 is coupled to the bottom surface of the film 909.

The film 909 may be positioned over a switch opening 916 of the switch body 902 and at least a portion of a top surface of the switch body 902. The switch assembly 900 may be formed by joining the film 909 of the cover member 908 to the switch body 902 using a laser welding process, in one example. Other suitable attachment techniques include ultrasonic welding, adhesives, mechanical attachments, co-molding, insert molding, and the like.

The actuation pad 906 (or other protrusion) may be formed from any suitable material, and may be the same material as the film 909 or a different material. In some cases, the actuation pad 906 is more rigid or stiff than the film 909. For example, the film 909 may be a substantially compliant material, such as a silicone or other elastomeric material, and the actuation pad 906 may be a rigid material that does not deform substantially when subjected to a typical actuation force of a key or button of an electronic device (e.g., a metal, hard rubber, a substantially rigid plastic such as acrylonitrile butadiene styrene (ABS), or the like). Like the actuation pad 510, the rigid actuation pad 906 may transfer force from a keycap, or other actuator or component, to the dome switch 904 without substantial deflection or deformation of the actuation pad 906 itself.

The flexible cover member 908, including the film 909 and the actuation pad 906, may be similar in function, materials, and structure to those described above with respect to the switch assemblies 200 and 500, and may be formed or produced in similar ways. For example, the cover member 908, and in particular the film 909, may substantially seal and protect dome switch 904. The film 909 may be formed from or include a material that is more flexible than the switch body 902. The flexibility of the film 909 may accommodate movement or deformation of film 909 when a keycap above the switch assembly 900 is depressed. In some cases, the film 909 may only be attached or affixed to the switch body 902 around an outer edge or perimeter of the film 909, which may also contribute to the ability of the film 909 to accommodate movement or deformation in response to a force from a keycap or other actuation member. Additionally, the film 909 may flex sufficiently to avoid preloading force on the dome switch 904 or substantially increasing the actuation force.

Moreover, like the cover members 208 and 508, the cover member 908 may be formed from or include an at least semi-transparent (e.g., translucent or transparent) material for transmitting and/or dispersing light emitted by a light source (not shown) toward a keycap. The light guiding and dispersing aspects described with respect to the switch assemblies 200 and 500 are equally applicable to the cover member 908 and the switch body 902.

In some embodiments, the dome switch 904 may be positioned within the switch opening 916 of the switch body 902, and may be held in place by positioning legs 914 of the dome switch 904 within recesses 912 formed in the switch body 902. The legs 914 may provide a biasing force to the dome switch 904 (e.g., tending to force the dome switch 904 towards an uncollapsed or unactuated state), and may also electrically connect the dome to electrical terminals, as described below.

The switch body 902 may include electrical terminals 915, 917. The electrical terminals 915, 917 may be molded in or otherwise integrated with the switch body 902. For example, metal terminals may be placed into a mold, and then material forming the switch body 902 may be introduced into the mold, at least partially encapsulating the metal terminals in the switch body 902.

The electrical terminals 915, 917 may have exposed portions within the switch opening 916 and on an external surface of the switch body 902. For example, one or more terminals 915 may be exposed within a recess 912. When the dome switch 904 is positioned in the switch body 902, a leg 914 of the dome switch 904 contacts the exposed portion of the terminal 915. Similarly, a portion of the terminal 917 may be exposed within the switch opening 916, such as in a central region of the opening 916. The exposed portion of the terminal 917 may be positioned so that the dome switch 904 contacts the exposed portion of the terminal 917 when the dome is collapsed due to actuation of the dome switch 904. This in turn forms a conductive path between the terminals 915, 917 through the dome switch 904. As noted, the terminals 915, 917 may also include or be conductively coupled to exposed portions on the outside of the switch body 902, such as contact pads 910. The contact pads 910 may be electrically coupled to electrical contacts of a substrate or keyboard base, such as a printed circuit board. Accordingly, an electronic device coupled to the keyboard can detect the closure of the circuit between the terminals 915, 917 and register an input.

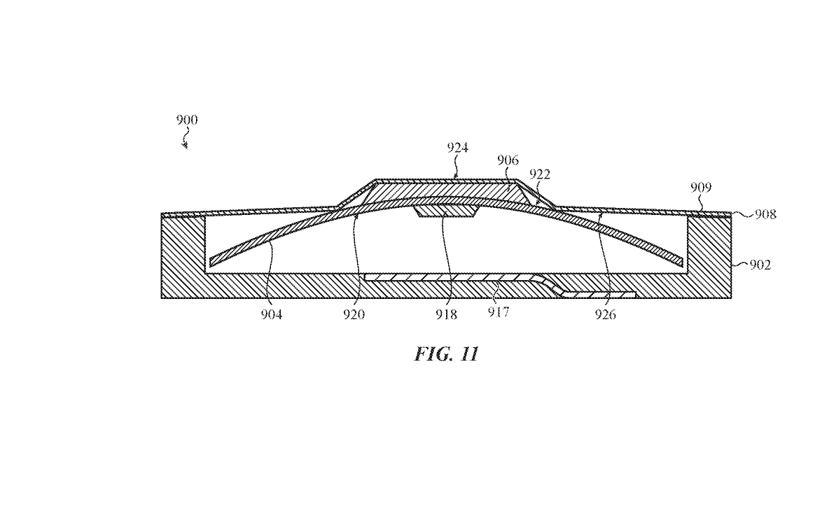

FIG. 11 is a cross-sectional view of the assembled switch assembly 900 of FIGS. 9 and 10, viewed along line CS-CS of FIG. 10. As shown in FIG. 11, the switch assembly 900 includes the switch body 902, the dome switch 904, and the cover member comprising the film 909 and the actuation pad 906. Whereas the actuation pad 510 in the switch assembly 500 is formed on an upper or top surface 526 of the film 509, the actuation pad 906 in the switch assembly 900 may be attached to or otherwise extend from an underside 926 of the film 909. Thus, a top surface 924 of the actuation pad 906 may contact a bottom surface the film 909. In a non-limiting example, the actuation pad 906 may be attached to the underside 926 of the film 909 using laser welding, ultrasonic welding, adhesives, or any other suitable process.

The switch assembly of FIG. 11 may function substantially similarly to the switch assemblies 200, 500 shown and discussed with respect to FIGS. 2-8B. In the non-limiting example shown in FIG. 11, the actuation pad 906 may cause the film 909 to protrude or extend towards an underside of a keycap, not shown, which may have a contact protrusion or similar feature for contacting the actuation pad 906. When a force is applied to depress a keycap, the keycap may contact the film 909 covering the actuation pad 906. This in turn forces the actuation pad 906 against the dome switch 904 and deforms the dome switch 904. The dome switch 904 may collapse under the force of the actuation pad 906 and complete a circuit between the terminals 915, 917.

Whereas the dome switches illustrated in FIGS. 4 and 7 include both an upper and lower dome, the dome switch 904 in FIG. 11 is an example of a single-dome configuration. In a non-limiting example shown in FIG. 11, the dome switch 904 may include a single dome structure having a contact nub or bump 918 extending from a bottom surface 920 of the dome switch 904. The dome switch 904 and the nub 918 may be formed from conductive material, such as metal, such that when the dome switch 904 is depressed, the nub 918 contacts the electrical terminal 917 and completes an electrical circuit from the terminal 915 to the terminal 917, as discussed herein. The dome switch 904 and the contact nub or bump 918 may be formed from a single piece of material. For example, the dome switch 904 may be stamped or cut (e.g., with a laser or water jet) from a sheet of metal or other conductive material. Alternatively, the nub or bump 918, formed from a conductive material, may be conductively coupled to the conductive material of the dome switch 904.

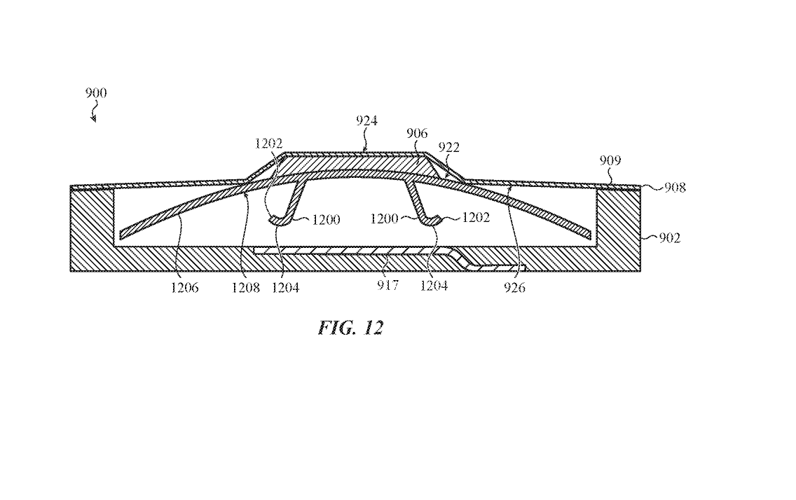

FIG. 12 illustrates the switch assembly 900 with another example of a collapsible dome 1206. In this example, the dome 1206 may have one or more protrusions 1200 extending from a bottom surface of the dome 1206. The dome 1206 and the dome protrusions 1200 may be formed from a conductive material, such as metal, for completing an electrical circuit between the terminals 915, 917, or any other electrical components. The dome protrusions 1200 may extend angularly toward a bottom surface of the switch body 902. The dome protrusions 1200 may include substantially flat, arm-like extensions that protrude from the bottom surface 1208 of the dome 1206. More particularly, as shown in FIG. 12, the dome protrusions 1200 may include substantially linear portions extending away from the bottom surface 1208 of the dome 1206. The dome protrusions 1200 also include curved portions 1202 at the distal ends of the dome protrusions 1200 (e.g., the ends opposite the junction between the dome protrusions 1200 and the dome 1206). As shown in FIG. 12, the curved portions 1202 may be formed integrally with and extend from substantially linear portions of the dome protrusions 1200. The curved portions 1202 may include or define curved contact surfaces 1204 for contacting the terminal 917 when the dome 1206 is deflected, thereby completing an electrical circuit between the terminals 915, 917.

The dome protrusions 1200 may deflect or deform when they contact the terminal 917. The deflection of the dome protrusions 1200 under these circumstances may contribute to and/or define the actuation force of the dome 1206. For example, as a key is depressed and imparts a force to the dome 1206, the dome protrusions 1200 eventually contact the terminal 917. As the dome protrusions 1200 are forced against the terminal 917, they may produce a responsive force countering the actuation force, thus increasing the amount of force required to collapse the key.

In some cases, the dome protrusions 1200 may be configured to contact the terminal 917 only after the dome 1206 buckles or collapses in response to an actuation force. Thus, when a user presses on the key, the collapse of the dome 1206 produces a haptic or tactile output that substantially corresponds to the dome protrusions 1200 contacting the terminal 917 (and thus registering an input). Additional force applied to the dome 1206 after the dome protrusions 1200 contact the terminal 917 may deflect the dome protrusions 1200. This may in turn impart a damped or spring-like response to the key. That is, instead of allowing a keycap to bottom-out against a hard stop, the dome 1206 will provide a softer, more damped end-of-travel response to the keycap.

In various embodiments, other switches may be used in conjunction with the switch assembly 900 instead of the single-dome switches described with respect to FIGS. 11-12. For example, switches that include upper and lower structures, such as the dome switches 205, 505, may be used in place of the dome switch 904.

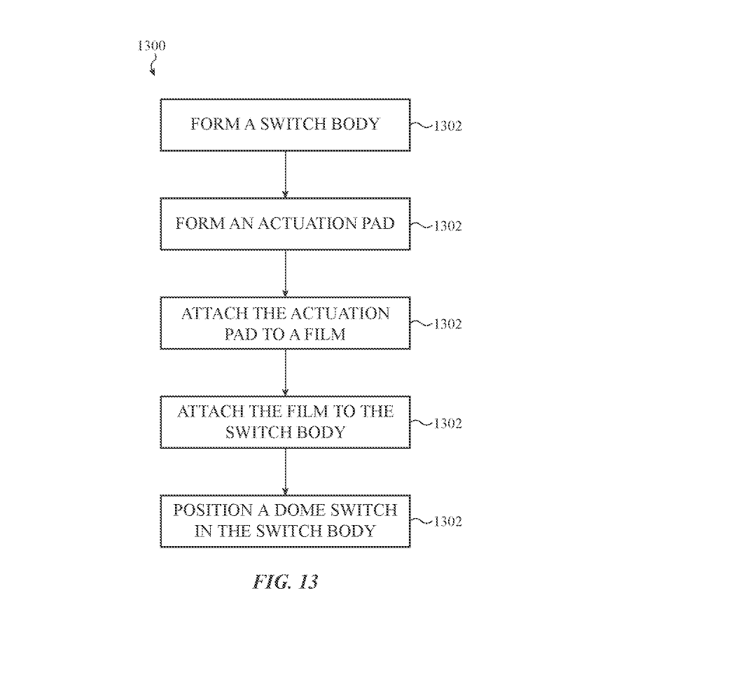

FIG. 13 depicts an example process 1300 for forming a switch. For example, FIG. 13 depicts an example process for assembling a switch body, a film, an actuation pad, and a collapsible dome to form a switch assembly for use within a keyboard assembly.

In operation 1302, a switch body (e.g., the switch body 202, 502, or 902) may be formed. The switch body may be formed using an injection molding process, or any other suitable process. The switch body may define a switch opening. The switch opening may be configured to receive and/or house a dome switch or other collapsible member, such as the domes switches 205, 505, or 904, described above. In a non-limiting example, the switch body may be formed from a material having substantially rigid properties for supporting a keycap in a keyboard assembly, and may be transparent, semi-transparent, and/or translucent to permit light emitted by a light source to pass through the switch body and, optionally, to direct the light towards a keycap. Additionally, the material of the switch body may be reflective, or the body may include reflective materials, to direct light emitted by the light source toward the keycap.

In operation 1304, an actuation pad (e.g., the actuation pad 210, 510, or 906) may be formed. The actuation pad may be formed using an injection molding process or any other suitable process. The actuation pad may define a top surface for interacting with a keycap in a keyboard assembly, and a bottom surface for interacting with a dome switch for a keyboard assembly. The actuation pad may be configured to transfer a force from the keycap to the dome switch of the switch assembly. Thus, in a non-limiting example, the actuation pad may be formed of a substantially rigid material for supporting the force applied by the keycap during operation of the key.

In operation 1306, the actuation pad may be attached to or joined with a film (e.g., the film 509, 909) to form a cover member (e.g., the cover member 508, 908). In a non-limiting example, the actuation pad may be affixed or attached to a surface of a film using a laser welding, ultrasonic welding, adhesives, or the like. As another example, the cover member may be formed by comolding or insert molding. For example, the actuation pad may be inserted into a mold, and then material may be injected or otherwise introduced into the mold to form the film and couple the film to the actuation pad. Alternatively, a film may be placed in a mold, and then material may be injected or otherwise introduced into the mold to form the actuation pad and couple the actuation pad to the film.

Where a cover member is a unitary or monolithic member, such as the cover member 208), instead of forming the actuation pad and then joining the actuation pad to a film (as described with reference to operations 1304, 1306), the cover member and the actuation pad may be formed in a single operation. For example, the cover member may be formed using an injection molding process (or any other suitable molding or forming process) that produces a film having an actuation pad extending from a surface of the cover member.

In operation 1308, the cover member may be affixed or attached to the switch body to form a switch assembly. More specifically, the cover member may be positioned such that the actuation pad of the cover member is positioned over the switch opening of the switch body, and more particularly, over a dome switch or other collapsible member. In the same operation, the film portion of the cover member may be positioned above and/or over a top surface of the switch body. The cover member may then be attached or otherwise secured to the switch body using laser welding, ultrasonic welding, adhesives, or any other suitable joining process. In this manner, the cover member may seal and protect the dome switch of the switch assembly.

In operation 1310, a dome switch may be positioned in the switch body. For example, the dome switch may be positioned within the switch opening of the switch body. The dome switch may be inserted in the switch opening using any suitable process, including by hand (e.g., a person may place the dome switch in the switch opening), by machine (e.g., a pick-and-place machine or assembly robot may place the dome switch in the dome opening), or by any combination of these or other techniques.

In some cases, such as where the dome switch is captured between a cover member and a bottom surface of a switch body, the dome switch/collapsible member may be positioned in the switch opening prior to affixing the cover member to the switch body. That is, operation 1310 may occur before operation 1308.

The foregoing description, for purposes of explanation, used specific nomenclature to provide a thorough understanding of the described embodiments. However, it will be apparent to one skilled in the art that the specific details are not required in order to practice the described embodiments. For example, embodiments herein are discussed with respect to a keyboard, but various embodiments may be used with (or incorporated into) a variety of devices other than smart phones, including computers, media players, health monitors, personal digital assistants, tablet devices, wearable electronic devices, keypads, and so on.

Likewise, although discussed herein as a keyboard assembly, it is understood that the disclosed embodiments may be used in a variety of input devices used with or in various electronic devices. That is, keyboard and/or the components of the keyboard assembly discussed herein may be utilized or implemented in a variety of input devices for an electronic device including, but not limited to, buttons, switches, toggles, touch screens, keypads, and the like.

Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A switch assembly, comprising:
a switch body defining a switch opening;
a dome switch positioned in the switch opening;
a film attached to the switch body and covering the switch opening; and
a protrusion extending from the film in an area above the switch opening; wherein
the protrusion is configured to transfer a force from a keycap of a key to the dome switch when the keycap is depressed.

2. The switch assembly of claim 1, wherein:
the switch assembly is one of a group of switch assemblies of a keyboard, the keyboard comprising:
a keyboard base; and
a group of keycaps movably supported relative to the keyboard base, wherein the keycap is one of the group of keycaps;
each respective switch assembly of the group of switch assemblies is coupled to the keyboard base and is positioned under a respective keycap of the group of keycaps.

3. The switch assembly of claim 2, wherein:
the switch body is configured to receive light from a light source;
the switch body transmits the light to the film; and
the film disperses the light toward the respective keycap of the keyboard.

4. The switch assembly of claim 3, wherein the film is substantially light transmissive for light received from below the film from the switch body and substantially reflective for light received from above the film.

5. The switch assembly of claim 1, further comprising a support mechanism movably supporting the keycap relative to the keyboard base.

6. The switch assembly of claim 1, wherein:
the film is formed from an elastomeric material; and
the protrusion is formed from a material that is different from the elastomeric material.

7. The switch assembly of claim 6, wherein the protrusion is fused to the film.

8. The switch assembly of claim 1, wherein the film is directly adjacent to a top of the dome switch.

9. A key, comprising:
a switch assembly, comprising:
a body defining a switch opening:
a flexible cover joined to the body; and
an actuation pad on a surface of the flexible cover; and
a keycap positioned above the switch assembly and operative to move from a first position to a second position; wherein
in the first position, the flexible cover is in a substantially undeformed state; and
in the second position, the flexible cover is deformed by the keycap.

10. The key of claim 9, wherein the keycap comprises a contact protrusion configured to contact the actuation pad when the keycap is in the second position.

11. The key of claim 9, wherein the switch opening includes a recess formed into a wall of the switch opening.

12. The key of claim 11, further comprising:
a dome switch positioned within the switch opening; wherein
a portion of the dome switch is received in the recess.

13. The key of claim 12, wherein the dome switch comprises:
an upper dome positioned adjacent the actuation pad; and
a lower dome disposed below the upper dome; wherein
the actuation pad deforms the upper dome when the keycap is in the second position.

14. The key of claim 13, wherein the upper dome completes an electrical connection with the lower dome when the keycap is in the second position.

15. The key of claim 12, wherein the dome switch comprises a dome protrusion on a surface of the dome switch.

16. The key of claim 15, wherein:
the actuation pad is configured to deform the dome switch when the keycap is moved to the second position; and
the dome protrusion is configured to contact an electrical terminal below the dome switch when the dome switch is deformed.

17. A method of forming a switch, comprising:
attaching a cover member comprising an actuation pad to a switch body that defines a switch opening; and
positioning a dome switch within the switch opening such that the actuation pad is aligned with an input surface of the dome switch.

18. The method of claim 17, further comprising forming the cover member, wherein forming the cover member comprises attaching the actuation pad to a film.

19. The method of claim 18, wherein the operation of attaching the actuation pad to the film comprises laser welding the actuation pad to the film.

20. The method of claim 18, wherein the operation of attaching the cover member to the switch body comprises laser welding the film to the switch body around a perimeter of the switch body.
